(19) United States
(12) Patent Application Publication
(10) Pub. No.: US 2012/0016817 A1
(43) Pub. Date: Jan. 19, 2012

(54) Predicting Life Changes of Members of a Social Networking System

(76) Inventors: S. Alex Smith, San Mateo, CA (US); David Braginsky, Mountain View, CA (US)

(21) Appl. No.: 12/839,350

(22) Filed: Jul. 19, 2010

(51) Int. Cl. G06F 15/18; G06F 15/16; G06N 5/02

(52) U.S. Cl. 706/12; 706/46; 709/217

(57) ABSTRACT

To predict a life change event for a user of the social networking system, such as a change in marital status, relationship status, employment status, etc., the disclosed system generates a training set of data comprising historical data of other users who have gone through a life change event. The system uses the training set data to generate a prediction algorithm using machine learning models. Furthermore, the system inputs the user data to the prediction algorithm to retrieve a prediction of whether the user will undergo one or more life change events. The system updates the user's profile to indicate the life change event and provides advertisements to the user responsive to the prediction of one or more life change events.

### BACKGROUND

This invention relates generally to social networking, and more specifically to using the data contained within a social network to predict or infer significant events in the lives of users of the social networking system.

Social networks, or social utilities that track and enable connections between users (including people, businesses, and other entities), have become prevalent in recent years. In particular, social networking systems allow users to share public and private information with other users, including information about significant events in the users' lives. These significant life events may include changes in marital status, birthdays, new jobs, the birth of new children, graduation, or death, just to name a few. One way for users to share life-changing event information is to add or update the information on their user profile. A user profile contains user provided information such as marital status, birthday, graduation date, and/or other user-specific data. Other users can then review the shared information by browsing user profiles or searching for profiles including specific data.

Social networking systems typically use the user-provided profile information to present additional information that may be relevant to the users. For example, information related to an entry level job placement may not be generally relevant to most users of the social networking system; however, the information is likely more relevant to a recent college or high school graduate. Thus users of the social networking system, or external parties such as advertisers use user profile information to target their message to an audience believed to be more receptive to the content of the message.

Advertisers in particular have attempted to leverage the profile information provided by users by targeting their ads to users whose interests best align with the products or services being advertised. For example, an advertiser using a social networking system may display banner ads for wedding locations to users who have updated their profile to indicate a change in marital status. However, targeting advertising to users is not very effective when the users' profiles are inaccurate or incomplete, which may occur because the profile information is supplied by the user and not verified for accuracy. Thus, in the above example, an advertiser may send promotional material or advertisements to a user who is married, but nonetheless has not reported as being married within the social networking system.

Even if a user profile is accurate, relevant advertisements often reach the intended recipient too late. Users of a social networking system generally do not update their profile information to reflect a life change event until after the event has occurred. Thus, in the above example, a user who got married may not update the new marital status on the social networking system until after the marriage. Consequently, an advertiser seeking to promote a wedding venue and relying on a user profile update will not reach the user until after the user likely has no need for a wedding venue.

An advertiser may try to predict that a user will get married at a future time if the user's profile indicates that the user is engaged. However, this system of prediction is unreliable because, as stated above, users do not update their profile very frequently and the profile information may not be accurate. Thus an advertiser could spend money to reach a user on a social networking system without reaching its target audience.

A social networking system and its users also rely on user provided profile information to communicate and interact with each user. A social networking system often uses user profile information to suggest friends or groups that may be of particular interest to each user. However, a social networking system and its users face problems similar to those outlined above, such as timeliness and accuracy of user provided profile information. Certain information is time sensitive and relevant only before a particular life change event occurs. Since users typically do not update their profile information until after the life change event has occurred, social networking systems relying on a profile update to provide such time sensitive information are bound to deliver the information too late. Similarly, user provided profile information may be inaccurate, resulting in inaccurate or irrelevant information suggestions.

### SUMMARY

To provide information to a user of the social networking system more effectively, and in a more timely fashion, it may be desirable to have information about the user's needs or an upcoming change in the user's needs in a more accurate manner. Rather than merely relying on a user's timeliness and accuracy in updating his or her profile information, embodiments of the invention predict life change events for a user based on the information available about the user accessible by the social networking system. A life change event, for example, may be a change in marital status, a birthday, a new job, a birth of a child, a graduation, or a death of a person associated with the user, just to name a few. Beyond simple reliance on a change in user profile information, the described approach is better able to use all the information contained in the social networking system such as wall posts, instant messages, e-mail messages, etc., to determine whether a user has undergone a life change event and/or to predict whether a user will undergo a life change event at a future time.

Predicting a life change event may allow the social networking system to suggest friends and groups that may be relevant to the user before the particular life change event. For example, the social networking system may suggest a group that helps users prepare for graduation, but the group is likely not of any particular interest to the user after the user has graduated. Similarly, advertisers can leverage the information contained within the social network to target their ads to a first user who will undergo a life change event along with users associated with the first user. For example, advertisers may target graduation memorabilia advertisements to a first user predicted to graduate in the near future. Additionally, the advertiser may target graduation gift advertisements to those closely associated with the first user. Thus, the present approach allows advertisers to target and deliver their message in a timely manner, while the ad content is still relevant to each target user.

In one embodiment, a social networking system predicts the probability that a user will undergo a life change event within a particular period of time. In one embodiment, this prediction is performed using a machine learning model that is trained using historical information from the social networking system. For example, the social networking system retrieves a list of other users who have indicated a similar life change event in their user profile information. In one embodiment, the social networking system retrieves communication, social network action data and metadata associated with each communication and action data for each user having undergone the life change event. The communication data, social network action data, associated meta data, whether the user went through a life change event and the type of life change event information is used to generate a training set used to train a machine learning module. Subsequently, the user communication and social network data is input to the machine learning model. The model outputs the probability (or some other indication of confidence) that the user will undergo a particular life change event within a particular time.

Additionally, the social networking system updates the user profile to include the predicted life change event. In one embodiment, the user profile update is not visible to other users of the social networking system. The social networking system can target content to the user based on the user profile update. In another embodiment, the social networking system targets content, advertisements, offers, or other information to the user based on the prediction of the user undergoing a life change event and the relationship of that information to the life change event.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a diagram of a system for predicting life change events of a user using the social networking system, in accordance with an embodiment of the invention.

FIG. 2 is a network diagram of a system for predicting life change events of users of a social networking system, in accordance with an embodiment of the invention.

FIG. 3 is a block diagram of a social networking system, in accordance with an embodiment of the invention.

FIG. 4 is a flow chart of a process for predicting life change events of a user of a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system and then add connections to a number of other users to whom they desire to be connected. As used herein, the term “friend” refers to any other user to whom a user has formed a connection, association, or relationship via the social networking system. Connections may be added explicitly by a user, for example, the user selecting a particular other user to be a friend, or automatically created by the social networking site based on common characteristics of the users (e.g., users who are alumni of the same educational institution). Connections in social networking systems are usually in both directions, but need not be, so the terms “user” and “friend” depend on the frame of reference. For example, if Bob and Joe are both users and connected to each other within the social networking system, Bob and Joe, both users, are also each other's friends. The connection between users may be a direct connection; however, some embodiments of a social networking system allow the connection to be indirect via one or more levels of connections. Also, the term friend need not require that users actually be friends in real life, (which would generally be the case when one of the users is a business or other entity); it simply implies a connection in the social networking system.

In addition to interactions with other users, the social networking system provides users with the ability to take actions on various types of items supported by the system. These items may include groups or networks (where “networks” here refer not to physical communication networks, but rather social networks of people) to which users of the social networking system may belong, events or calendar entries in which a user might be interested, computer-based applications that a user may use via the system, and transactions that allow users to buy or sell items via the system. These are just a few examples of the items upon which a user may act on a social networking system, and many others are possible.

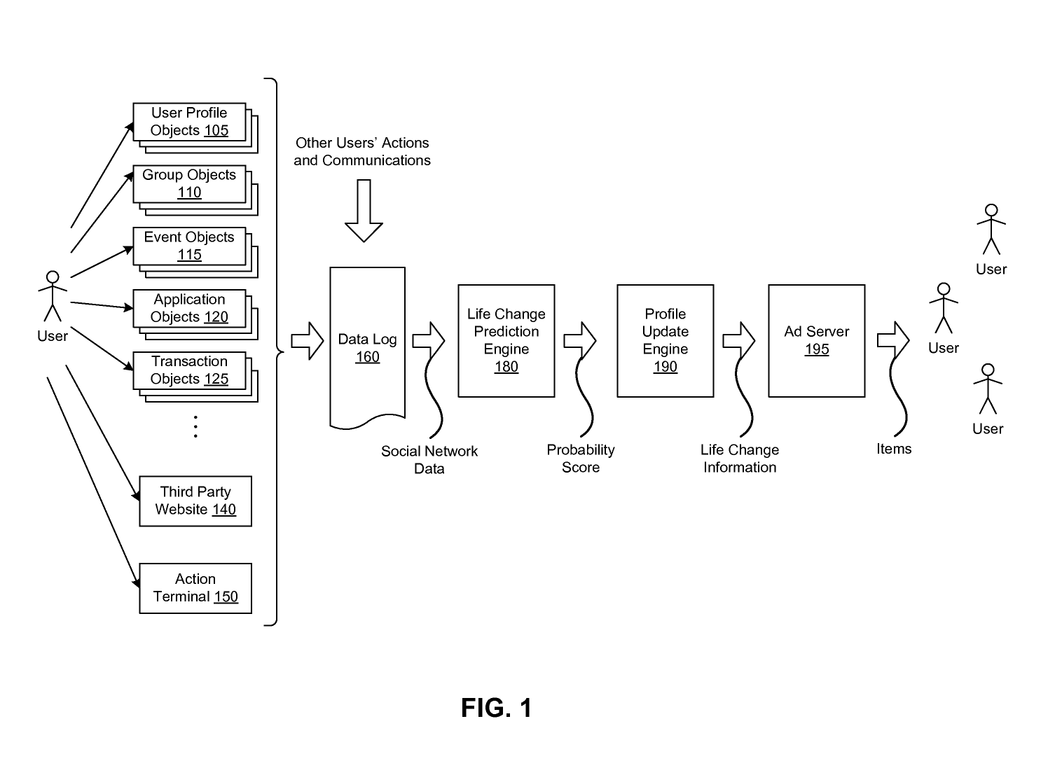

FIG. 1 illustrates a system for predicting life change events of a user of the social networking. In one embodiment, user data accessible by the social networking system such as profile data or communications data is stored in a data log 160. A life change prediction engine 180 retrieves the social network data associated with the user and applies a machine learning algorithm to determine the probability of the user undergoing a life change event at a future time. In an embodiment, the machine learning algorithm uses historical social network data associated with other users who have undergone a life change event to predict the probability of the user undergoing the life change event. The profile update engine 190 provides updates the social networking system's profile data store to reflect the predicted life change event or an upcoming life change event. Additionally, the item service module 195 serves one or more items to the user or other users associated with the user based on the life change event predicted by the life change prediction engine 180.

As illustrated, the system of FIG. 1 can be used for predicting life change events for a user by retrieving object data for a data log 160. In one example embodiment, these objects include user profiles 105, group objects 110, event objects 115, application objects 120, and transaction objects 125 (respectively, hereinafter, groups 110, events 115, applications 120, and transactions 125). In one embodiment, an object is stored by the social networking system for each instance of its associated item. For example, a user profile 105 is stored for each user who joins the social networking system, a group 110 is stored for each group defined in the social networking system, and so on. The types of objects and the data stored for each is described in more detail below.

The user of the social networking system may take specific actions on the system, where each action is associated with one or more objects. The types of actions that a user may perform in connection with an object are defined for each object and largely depend on the type of item represented by the object. A particular action may be associated with multiple objects. Described below are a number of examples of particular types of objects that may be defined for the social networking system, as well as a number of actions that can be taken for each object. These objects and the actions discussed herein are provided for illustration purposes only, and it can be appreciated that an unlimited number of variations and features can be provided on a social networking system.

The social networking system maintains a user profile 105 for each user of the system. Any action that a particular user takes with respect to another user is associated with each user's profile 105. Such actions may include, for example, adding a connection to the other user, sending a message to the other user, reading a message from the other user, viewing content associated with the other user, attending an event posted by another user, among others. In addition, a number of actions described below in connection with other objects are directed at particular users, so these actions are associated with those users as well.

A group 110 may be defined for a group or network of users. For example, a user may define a group to be a fan club for a particular band. The system would maintain a group 110 for that fan club, which might include information about the band, media content (e.g., songs or music videos) by the band, and discussion boards on which users of the group can comment about the band. Accordingly, user actions that are possible with respect to a group 110 might include joining the group, viewing the content, listening to songs, watching videos, and posting a message on the discussion board.

Similarly, an event 115 may be defined for a particular event, such as a birthday party. A user may create the event 115 by defining information about the event such as the time and place and a list of invitees. Other users may accept the invitation, comment about the event, post their own content (e.g., pictures from the event), and perform any other actions enabled by the social networking system for the event 115. Accordingly, the creator of the event 115 as well as the invitees for the event may perform various actions that are associated with that 115.

The social networking system may also enable users to add applications to their profiles. These applications provide enhanced content and interactivity within the social networking system, which maintains an application object 120 for each application hosted in the system. The applications may be provided by the system operator and/or by third party developers. An example application is an enhanced messaging service, in which users can send virtual objects (such as a “gift” or “flowers”) and an optional message to another user. The use of any functionality offered by the application may thus constitute an action by the user in connection with the application 120. In addition, continuing the example from above, the receipt of the virtual gift or message may also be considered an action in connection with the application 120. It can therefore be appreciated that actions may be passive and need not require active participation by a user.

Another type of object shown in the example of FIG. 1 is a transaction 125. A transaction object enables users to make transactions, such as buying, selling, renting, trading, or exchanging with other users. For example, a user may post a classified ad on the social networking system to sell a car. The user would thus define a new transaction 125, which may include a description of the car, a picture, and an asking price. Other users can then view this information and possibly interact further with the transaction 125 by posting questions about the car and accepting the offer or making a counteroffer. Each of these interactions—view, question posting, offer, and counteroffer—are actions that are associated with the particular transaction 125.

When a user takes an action on the social networking system, the action is recorded in an data log 160. In one embodiment, the social networking system maintains the data log 160 as a database of entries. When an action is taken on the system, therefore, the system adds an entry for that action to the log 160. In one embodiment, an entry comprises some or all of the following information:
Time: a timestamp of when the action occurred.
User: an identifier for the user who performed the action.
Target: an identifier for the user to whom the action was directed.
Action Type: an identifier for the type of action performed.
Object: an identifier for an object acted on by the action.
Content: content associated with the action.

It can be appreciated that many types of actions that are possible within the social networking system need not require all of this information. For example, if a user changes a picture associated with the user's profile, the action may be logged with just the user's identifier, an action type defining a picture change, and the picture or a link thereto as the content.

In one embodiment, the social networking system also logs actions that a user takes on a third party website 140. The social networking system may learn of the user's actions on the third party website 140 via any of a number of methods. For example, the third party website 140 may send a message to the social networking system when a particular action by a user occurs on the third party website 140. In one example, if the third party website 140 is a commercial website on which users may purchase items, the third party website 140 may inform the social networking system when a user of the social networking system buys an item on the third party website 140.

In another embodiment, the social networking system logs actions taken by its users in the real world. These actions may be recorded by an action terminal 150, which observes qualifying actions and then communicates that action to the social networking system. The communication may be via email, SMS, or any other appropriate means, where the communicated message includes sufficient information for the social networking system to populate the data log 160 with an entry describing the action. The action terminal 150 may comprise any suitable devices or systems for the particular type of action to be tracked.

In one embodiment, the action to be tracked is a credit card transaction, where a user of the social networking system may optionally opt in by registering a credit card. When the registered credit card is used in a qualifying way (e.g., a purchase made at a point of sale), the credit card company (or clearinghouse) sends a message to the social networking system. In this scenario, a computing system at the credit card company or clearinghouse serves as a action terminal 150. The message may contain information about the credit card transaction, such the item purchased, the date, and location of the purchase. The social networking system thus tracks real-world actions such as this purchase in the data log 160.

Another example illustrating real-world actions that may be tracked involves the user's location. A user may configure a cellular phone having location technology (e.g., GPS) to communicate the user's location to the social networking system. This may be accomplished, for example, by downloading an application to the cellular phone, where the application polls the location unit in the phone and sends a message containing the user's location to the social networking system. This may be performed periodically or upon certain triggering events associated with locations. For example, a triggering event can include the user being within to a specific city, or at particular destination such as a restaurant, business, or venue. In this application, the cellular phone (or other GPS-enabled device) serves as the action terminal 150.

Another example illustrating real-world actions that may be tracked involves what program material the user is accessing on a television system. A television and/or set-top receiver may act as an action terminal 150 and transmit a message indicating that a user is viewing (or recording) a particular program on a particular channel at a particular time. Again, these examples are presented to illustrate some of the types of devices and actions that may be captured as actions by a user and communicated to the social networking system. A limitless variety of other applications may be implemented to capture real-world actions associated with a particular user and send that information to the social networking system.

After an amount of time, the data log 160 will become populated with a number of entries that describe actions taken by and communication associated with the users of the social networking system. The data log 160 thus contains a very rich set of data about the actions of the users, and can be analyzed and filtered to identify trends and relationships in the actions of the users, as well as affinities between the users and various objects. In one embodiment, the data log can be analyzed to identify key words indicative of a life change event.

The life change prediction engine 180 predicts a life change event for the user of the social networking system. A life change event, for example, may be a change in marital status, a birthday, a new job, a birth of a child, a graduation, or a death of a person associated with the user, just to name a few. If for example, the life change prediction engine 180 predicts the probability of a user getting married within a particular period of time, the life change prediction engine 180 retrieves communication and social network action data for each user of the social networking system who has changed user marital status from single or engaged to married. Additionally, the life change prediction engine 180 removes the communications and action data of users who whose profile marital status was changed on dates provided by the social networking system. For example, the social networking system may provide that users indicating a change in marital status on April first are not reliable data points. The life change prediction engine 180 identifies one or more key words within the retrieved data indicative of a change in marital status and generates a training data set comprising of the identified key words, whether the user went through a life change event and the type of life change event. Subsequently, the user's communication and action data is input to the machine learning model. The model outputs the probability that the user will undergo a particular life change event within a particular time.

The profile update engine 190 updates a user profile database within the social networking system. In one embodiment, the profile update engine 190 receives a life change probability score from the life change prediction engine 180. Responsive to a high probability score for a user undergoing a life change event, the profile update engine 190 updates the user profile indicative of the life change event. In one embodiment, the profile update is not visible by other users of the social networking system.

The item serving module 195 serves items to the user within the social networking system. Items comprise virtual gifts, messages, advertisements, invitations or other objects within the social networking system described above. In one embodiment, the item serving module 195 servers an item to the user responsive to the profile update enabled by the profile update engine 190. For example, the item serving module 195 can serve the user with advertisements regarding wedding announcements or thank you notes if the profile update engine updates the user profile indicating that the user got married or will get married. Additionally, the item serving module 195 can serve items to other users within the social networking system associated with the user. For example, the item serving module can display advertisements regarding wedding gifts to other users associated with the user.

### System Architecture

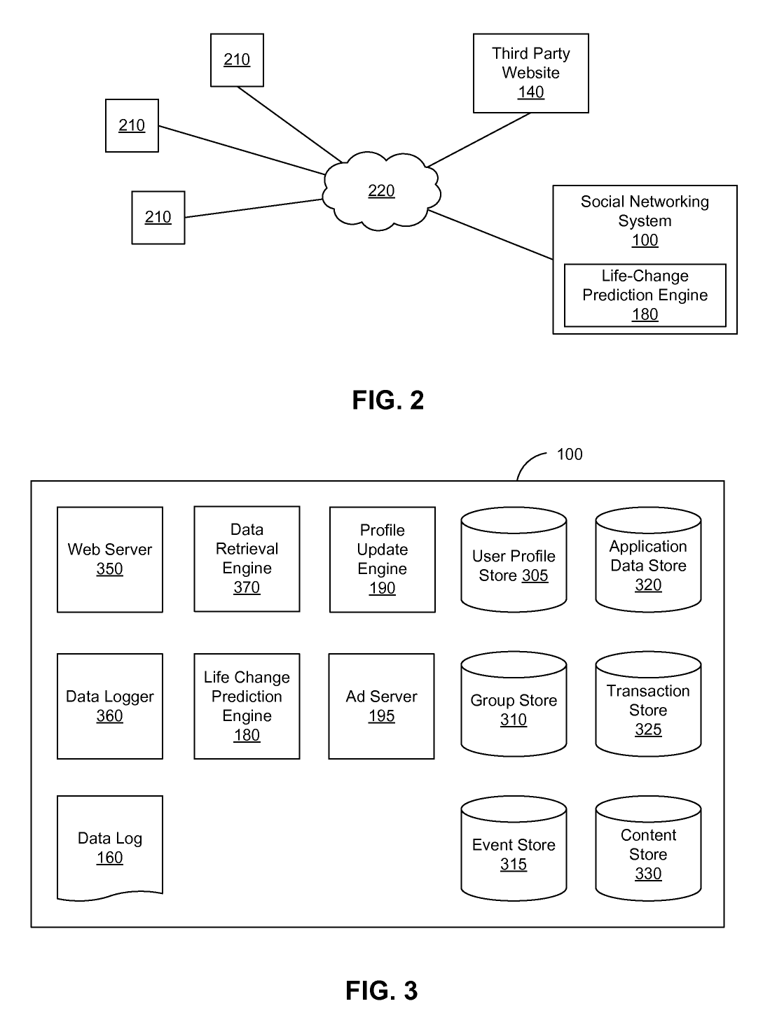

FIG. 2 is a high level block diagram illustrating a system environment suitable for operation of a social networking system 100. The system environment comprises one or more client devices 210, one or more third-party websites 140, a social networking system 100, and a network 220. In alternative configurations, different and/or additional modules can be included in the system.

The client devices 210 comprise one or more computing devices that can receive member input and can transmit and receive data via the network 220. For example, the client devices 210 may be desktop computers, laptop computers, tablet computers (pads), smart phones, personal digital assistants (PDAs), or any other device including computing functionality and data communication capabilities. The client devices 220 are configured to communicate via network 220, which may comprise any combination of local area and/or wide area networks, using both wired and wireless communication systems. As described above, the third party website 140 and the action terminal 150 are coupled to the network 220 for communicating messages to the social networking system 100 about the users' actions off the system 100.

The social networking system 100 comprises a computing system that allows users to communicate or otherwise interact with each other and access content as described herein. In one embodiment, the social networking system 100 stores member profiles that describe the users of a social network, including biographic, demographic, and other types of descriptive information, such as work experience, educational history, hobbies or preferences, location, and the like. The system 100 further stores data describing one or more relationships between different users. The relationship information may indicate users who have similar or common work experience, group memberships, hobbies, or educational history. Additionally, the social network permits users to submit user defined relationships between different users, allowing users to specify their relationships with other users. For example, these member defined relationships allows users to generate relationships with other users that parallel the users' real-life relationships, such as friends, co-workers, partners, and so forth. Users may select from predefined types of relationships, or define their own relationship types as needed.

FIG. 3 is an example block diagram of a social networking system 100. The social networking system 100 includes a web server 350, an data logger 360, an data log 160, a newsfeed generator 370, an ad server 380, a database of ad requests 175, a member profile store 305, a group store 310, an event store 315, an application data store 320, a transaction store 325, and a content store 330. In other embodiments, the social networking system 100 may include additional, fewer, or different modules for various applications.

The web server 350 links the social networking system 100 via the network 220 to one or more client devices 210, as well as to one or more third party websites 140. The web server 350 may include a mail server or other messaging functionality for receiving and routing messages between the social networking system 100 and the client devices 210 or third party websites 140. The messages can be instant messages, queued messages (e.g., email), text and SMS messages, or any other suitable messaging technique.

The data logger 360 is capable of receiving communications from the web server 350 about member actions on and/or off the social networking system 100. The data logger 360 populates the data log 160 with information about these member actions and communications tracked in the object data stores. As discussed above, the social networking system 100 maintains data about a number of different types of objects with which a member may interact on the system 100. To this end, each of the member profile store 305, the group store 310, the event store 315, the application data store 320, and the transaction store 325 store data structures to manage the data for each instance of the corresponding type of object maintained by the system 100. The data structures comprise information fields that are suitable for the corresponding type of object. (For example, the event store 315 contains data structures that include the time and location for an event, whereas the member profile store 305 contains data structures with fields suitable for describing a member's profile.) When a new object of a particular type is created, the system 100 initializes a new data structure of the corresponding type, assigns a unique object identifier to it, and begins to add data to the object as needed. This might occur, for example, when a member defines a new event, wherein the system 100 would generate a new instance of an event in the event store 315, assign a unique identifier to the event, and begin to populate the fields of the event with information provided by the member.

The data retrieval engine 370 retrieves data associated with users who have indicated a life change event in their user profile. For example if a user profile indicates a change in marital status from single or engaged to married, the data retrieval engine 370 retrieves the user's data. In another embodiment, the data retrieval engine 370 retrieves the user's communications logs dating from a particular time before the life change event to the life change event date. For example if the social networking system provides that the data retrieval engine 370 retrieve data from a week before the reported life change event date, the life change prediction engine 180 retrieves user data logs starting from a week before the reported life change event data to the reported life change event data.

The life change prediction engine 180 predicts a life change event for a user of the social networking system. As described above in reference to FIG. 1, life change events comprise a change in marital status, relationship status, age, graduation status, employment statues, a change in the number of family members such as newborn or adopted children or siblings or death of a person or a pet associated with the user. In one embodiment, the life change prediction engine 180 computes the probability of a user undergoing a life change event using a machine learning model and historical data of other users of the social networking system who have went through life change events. In one embodiment, the machine learning model of the life change prediction engine 180 is trained using the data logs 106 retrieved for each user, whether each user went through a life change event and the type of life change event. The machine learning model can use several data points within the retrieved data as variables to generate a predictive algorithm. For example, the use of words such as “congratulations,” presence of virtual gifts offered to the users, the number of times other users clicked on each user profile, change in other profile information, such as address or last name, the number of new friends or connections made within the social networking system etc. The life change prediction engine uses the data log 160 of the first user as input signal to the life change prediction engine 180. In one embodiment, the life change prediction engine 180 outputs a probability score indicative of whether the user will undergo particular life change event based on historical data of other users. In one embodiment, the life change prediction engine 180 classifies the user as going through a life change event if the probability score of the user is higher than a threshold score provided by the social networking system. In another embodiment, life change prediction engine 180 identifies words indicative of a life change event in the user communications data. The words can be provided by the social networking system. In such an embodiment, the life change prediction engine assigns a high probability of a life change event to the user whose communications data indicates a high incidence of the identified words.

The profile update engine 190 updates user's profile indicating a life change event. It should be noted that although a user profile is generally updated by the user, the profile update engine 190 updates the user profile for the social networking system. In one embodiment, the user or other users of the social networking system can withhold the profile updates made by the profile update engine 190 from being accessible by the user or other users of the social networking user. In such an embodiment, the user profile update information is used internally, by the social networking system for the purposes of the providing relevant information to the user of the social networking system.

The item serving module 195 serves one or more items to users of the social networking system. In one embodiment, the item serving module 195 serves items to users whose profile have been updated by the profile update engine 190 indicating a life change event. For example, if the profile update engine 190 updates a user's profile indicating that the user will get married, the item serving module 195 can serve virtual wedding gifts to the user. In such an embodiment, the ad server 195 can serve to the user advertisements that have a marriage targeting criteria. Advertisers can provide one or more targeting criteria indicating that an advertisement can only be served to particular users. For example, an advertiser can provide that a advertisement for wedding venue should only be served to users identified as getting married. Thus, the ad server 195 can serve ads to those users whose profile information as updated by the profile update engine 190 meets the advertiser provided targeting criteria.

In another embodiment, the ad server 195 serves items to users associated with the user predicted to go through a life change event. Continuing with the above example, if a user is predicted to get married, the ad server can serve virtual wedding gift advertisements to users associated with the user. In such an embodiment, the associated users can purchase a virtual wedding gift to offer to the first user. In another embodiment, if an advertiser provides that an advertisement be served to users associated with a user getting married, the ad server 195 can serve those advertisements to the associated users. For example, the ad server 195 can, responsive to an advertiser provided advertising criteria, serve wedding gift advertisements to users associated with the first user predicted to get married.

### Predicting Life Change Events for Users of the Social Networking System

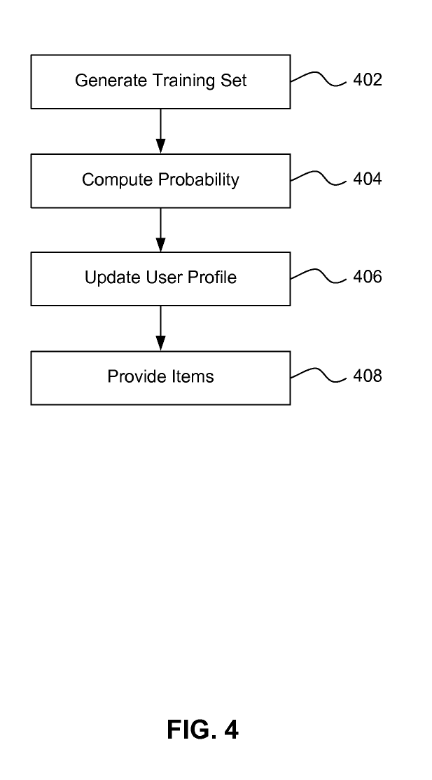

FIG. 4 illustrates a process in which the social networking system predicts a life change event for a user of the social networking system. In one embodiment, the social networking system executes the method illustrated in FIG. 4 for all users of the social networking system. In another embodiment, the process of FIG. 4 is executed for users whose profile information has changed.

The process 400 generates 402 a training set used to train a machine learning model. The process 400 identifies one or more users within the social networking system who have undergone a life change event. For example, if a user profile shows that the user changed marital status information, employment information or home address information, the process 400 identifies the user. Additionally the process 400 retrieves communications data and social network data performed by the user or other users in association with the user. In such an embodiment, the process 400 can retrieve communications and action data for a particular time period before the life change event is recorded on the user profile. For example, the process 400 can retrieve data from a week or a month prior to the life change event. In another embodiment, time frame and duration of the retrieved data can vary based on the life change event indicated by the user. The process 400 can retrieve communications and action data from a month prior to a marital status change, whereas the process 400 can retrieve communications and action data from two days prior to a change in age. In one embodiment, the process 400 removes or discounts life change events that occur on particular dates. For example, the social networking system can provide that change in relationship status on April first is not a reliable indicator of the life change event. In such an embodiment, the process 400 removes the user data associated with such users. Additionally, the process generates 402 a training data based on the retrieved data, whether the user went through a life change event and type of life change event.

The process 400 computes 404 the probability of a user undergoing a life change event based on the user's communications and actions within the social networking system and the training data set. In one embodiment, the process 400 trains a machine learning model using the training data. The machine learning model can take into several factors in generating a prediction algorithm, such as the words comprising communications associated with the user, the length of the communication, the frequency of the communication, the type of actions taken, such as receiving virtual gifts from other users, creating an event corresponding to the life change event date, etc. Responsive to the training set, the machine learning model generates a prediction algorithm. Once the process 400 inputs communication and action data associated with the user the machine learning model uses the prediction algorithm to compute 404 the probability of a user undergoing a particular life change event. Additionally, if the user's probability score is above a provided threshold score, the user is predicted to go through a life change event.

The process updates 406 the user profile responsive to the prediction that the user will go through a life change event. In one embodiment, the process updates 406 the user profile such that the updated information is not available to the user or other users of the social networking system. In another embodiment, the user profile can be updated by adding a value to the user profile store 305.

The process provides 408 items to the user responsive to the prediction that the user will go through a life change event. In one embodiment, the process provides 408 virtual goods or gifts to the user based on the predicted life change event. For example, if the user is predicted to get married, the process can provide 408 a virtual wedding gift to the user. In another embodiment, the process can provide 408 advertisements to the user based on the predicted life change event and the advertiser provided targeting criteria for the advertisement. For example, if an advertiser provides that an advertisement should only be served to users who will get married, the process provides 408 the advertisement to users who are predicted to get married. In another embodiment, the process provides 408 the items to users of the social networking system associated with the user predicted to go through a life change event. For example, the process 408 can provide links to virtual wedding gifts to other users, wherein the other users can select and send the virtual gift to the user predicted to get married. In another embodiment, the process serves 408 advertisements to users associated with the user predicted to go through a life change event based on advertisement criteria. For example if an advertiser provides friends of a user predicted to get married should be targeted with a particular advertisement, the user process provides 408 the advertisement to the friends or users associated with the user predicted to get married.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for predicting a life change event of a user of a social networking system, the method comprising:
retrieving communication data associated with the user of the social networking system, the communication data comprising messages, wall posts, instant messages, feed posts or text messages;
parsing the communication data to obtain one or more key words indicative of a life change event;
predicting a life change event for the user responsive to the obtained key words; and
storing information about the prediction in association with the user data.

2. The method of claim 1, wherein life change event comprises a change in marital status, relationship status, age, employment status, graduation status, health status, addition of new children or death of a person associated with the user outside the social network.

3. The method of claim 1, wherein communication data received by the user within a particular time period is retrieved.

4. The method of 1, wherein storing prediction information comprises updating the user profile associated with the social networking system.

5. The method of claim 1, further comprising:
removing life change data from historical data responsive to a life change event occurring on a particular day.

6. The method of claim 1, further comprising:
selecting a content item for the user related to the detected life change event; and
sending the selected content to the user.

7. The method of claim 1, further comprising displaying one or more advertisements to the user selected based on the predicted life change event.

8. The method of claim 1, further comprising:
identifying users of the social networking system who have undergone a life change event;
determining life change event for each identified user; and
retrieving historical communications data associated with each identified user.

9. The method of claim 8, wherein users of social networking system who have undergone a life change event are identified based on user provided data.

10. A method for predicting a life change event of a user of a social networking system, the method comprising:
obtaining historical communications data that describes historical communications within the social networking system, the historical communications data associated with users who have undergone a life change event;
training a machine learning model using the obtained historical communications data;
obtaining information about communications associated with a particular use of the social networking system; and predicting a life change event for the user using the machine learning model and the obtained information.

11. The method of claim 10, wherein life change event comprises a change in marital status, relationship status, age, employment status, graduation status, health status, addition of new children or death of a person or a pet associated with the user outside the social network.

12. The method of claim 10, wherein historical communications data comprises messages, wall posts, instant messages, photo comments, posted links, gifts, uploaded photos, videos and music associated with users of the social networking system who have undergone a life change event.

13. The method of claim 10, wherein historical communications data comprises communications associated with a user a week before the life change announcement by the user.

14. The method of claim 10, further comprising:
removing life change data from historical data responsive to a life change event occurring on a particular day.

15. The method of claim 10, further comprising:
selecting a content item for the user based on the predicted life change event; and
sending the selected content item to the user.

16. The method of claim 10, further comprising displaying one or more items to the user responsive to the predicted life change event.

17. The method of claim 10, further comprising:
identifying users of the social networking system who have undergone a life change event;
determining life change event for each identified user;
retrieving historical communications data associated with each identified user;
parsing the retrieved historical communications data to obtain a plurality of key words indicative of a life change event; and
obtaining the one or more key words within the communications data indicative of the life change event, each key word and associated life change event being used as signals to train the machine learning model.

18. The method of claim 17, wherein users of social networking system who have undergone a life change event are identified based on user provided data.
